(19) United States
(12) Patent Application Publication
(10) Pub. No.: US 2022/0159162 A1
(43) Pub. Date: May 19, 2022

(54) IMAGING COMPENSATION DEVICE, IMAGING COMPENSATION METHOD, AND APPLICATION

(71) Applicant: Wuhan China Star Optoelectronics Semiconductor Display Technology Co., Ltd., Wuhan (CN)

(72) Inventors: Liang SUN, Wuhan (CN); Mian ZENG, Wuhan (CN)

(21) Appl. No.: 16/630,470

(22) PCT Filed: Aug. 27, 2019
(86) PCT No.: PCT/CN2019/102715

§ 371 Date: Jan. 13, 2020

(30) Foreign Application Priority Data
Aug. 2, 2019 (CN) 201910709985.8

(51) Int. Cl. H04N 5/235; H04N 5/225; G06T 7/00

(52) U.S. Cl. CPC H04N 5/235; G06T 7/97; H04N 5/2257

(57) ABSTRACT

The invention provides an imaging compensation device, method, and application. The imaging compensation method comprises the steps of: capturing a first image from a predetermined object by a camera; capturing a second image from the predetermined object through a display panel by the camera installed under the display panel; analyzing difference between parameters of the first image and parameters of the second image to construct an imaging compensation algorithm; and using the imaging compensation algorithm to compensate parameters of a last obtained image captured through the display panel by the camera.

### BACKGROUND OF INVENTION

### Field of Invention

The invention relates to a technical field of display panel, in particular to an imaging compensation device, imaging compensation method, and application.

### Description of Prior Art

Along with the thriving mobile phone industry, mobile phone display technology is also progressing vigorously and abundantly with various functions. Current mobile phone displays have been increasingly equipped with camera modules. A camera device and a display are individual devices and need to be placed separately, which can limit the space for locating a display, and depart from the current trend of maximizing screen occupation ratio of smartphone. Since camera module is an indispensable part of current mobile phone, how to integrate camera and display to maximize screen occupation ratio is a challenge that demands prompt solutions.

Sources say that new solutions for higher screen occupation ratio are around the corner. Although no real mass produced product is currently available on the market, such solutions are pursued and developed by various vendors. The main idea is to dig a hole on a display panel to accommodate a front camera lens, and locate a camera module under the panel.

In a current mobile phone camera structure, a scene is captured through a lens to project an optical image onto a sensor. The optical image is converted into electrical signals, which are subsequently converted to digital signals. The digital signals are processed by digital signal processing (DSP), then sent to a mobile phone processor for further processing, and eventually converted into a visible image on a phone display. A DSP chip mainly optimizes digital signals and parameters of images through a series of complex mathematical algorithms and sends the processed signals through an interface, such as universal serial bus (USB). DSP architecture comprises: 1. an image signal processor (ISP); 2. a Joint Photographic Experts Group (JPEG) encoder or a JPEG image decoder; and 3. a USB device controller.

In current under-screen camera technology, light beams have to pass through the display panel and may suffer from low transmittance in some light bands along the way before entering into the camera lens for imaging. The display panel inherently has an array structure with some light blockage parts. All of these contribute to the causes of color cast, reduced resolution, and other impacts on imaging.

Hence, a new type of imaging compensation device to address the shortcomings of current technology is desirable.

### SUMMARY OF INVENTION

### Technical Problems

One objective of the invention is to provide an imaging compensation device, which can solve the problem of poor imaging quality of an current under-screen camera due to low transmittance in an under-screen camera area.

### Technical Solutions

To achieve the purpose, the invention provides an imaging compensation device comprising a memory and a processor. The memory stores a first image obtained from capturing a predetermined object by a camera. The first image comprises parameters for the first image. The camera is installed under a display panel and captures the predetermined object to obtain a second image. The second image is stored in the memory and includes parameters for the second image. The processor analyzes difference between the parameters of the first image and the parameters of the second image to constitute an imaging compensation algorithm, and uses the imaging compensation algorithm to compensate parameters of a last obtained image captured through the display panel by the camera.

In particular, the predetermined object comprises a number of two or more objects.

In particular, the parameters of the first image and the parameters of the first image include a grayscale value, a resolution, and a chromaticity.

Another aspect of the invention is to provide an imaging compensation method comprising: capturing a first image from a predetermined object by a camera, wherein the first image comprises parameters for the first image; capturing a second image from the predetermined object through a display panel by the camera installed under the display panel, wherein the second image includes parameters for the second image; analyzing difference between the parameters of the first image and the parameters of the second image to constitute an imaging compensation algorithm; and using the imaging compensation algorithm to compensate parameters of a last obtained image captured through the display panel by the camera.

In particular, the predetermined object comprises a number of two or more objects.

In particular, the parameters of the first image and the parameters of the first image include a grayscale value, a resolution, and a chromaticity.

Another aspect of the invention is to provide a terminal device including a body equipped with an under-screen camera on the body. The under-screen camera comprises a lens, a sensor, an analog to digital converter, and a digital signal processing chip. The digital signal processing chip comprises an image signal processor and the imaging compensation device of the invention.

In particular, during grayscale compensation for the last obtained image, the image signal processor compensates grayscale values of the last obtained image by adjusting display brightness.

In particular, during resolution compensation for the last obtained image, the image signal processor compensates resolution of the last obtained image by adjusting display clarity.

In particular, the image signal processor use an auto white balance (AWB) algorithm to compensate chromaticity of the last obtained image.

In particular, the terminal device comprises a mobile phone.

### Useful Effects

Compared with the current technology, the beneficial effect of the present invention is: the present invention provides an imaging compensation device, an imaging compensation method, and an application. A DSP chip in the under-screen camera has a built-in imaging compensation device. The imaging compensation device includes a memory and a processor. The memory stores a first image obtained from directly capturing a predetermined object by a camera. The first image comprises first image parameters. The camera is installed under a display panel. The camera obtains a second image from capturing the predetermined object through the display panel. The second image is stored in the memory and includes second image parameters. The processor analyzes the difference between the first image parameters of the first image and the second image parameters of the second image to form an imaging compensation algorithm, and uses the imaging compensation algorithm to compensate image parameters of a last obtained image captured by the camera through the display panel. Through the camera design with the imaging compensation function, every pixel of images captured by the camera under an array of display pixels is compensated in grayscale, color cast, and resolution to improve under-screen camera imaging.

### BRIEF DESCRIPTION OF DRAWINGS

To clearly disclose the technical solution of the embodiments according to the present invention, a brief description of the drawings that are necessary for the illustration of the embodiments will be given as follows. Apparently, the drawings described below show only example embodiments of the present invention, and for those having ordinary skills in the art, other drawings may be easily obtained from these drawings without paying any creative effort.

FIG. 1 is a flowchart showing an imaging compensation method according to a first embodiment of the invention.

### DETAILED DESCRIPTION OF PREFERRED EMBODIMENTS

Technical schemes in embodiments of the present invention are clearly and comprehensibly described in the following accompany with the drawings. Obviously, the embodiments to be detailed are only illustrative rather than exhaustive description of embodiments of the present invention. Based on embodiments of the present invention, all other embodiments obtainable by a person with ordinary skill in the art without making creative labors are construed as belonging to the scope of the claimed invention.

The specific structural and functional details disclosed here are merely proposed for examples and embodiments of the invention. However, the invention can be implemented in a number of alternative forms and should not be interpreted as merely subject to the embodiments described here.

### Embodiment 1

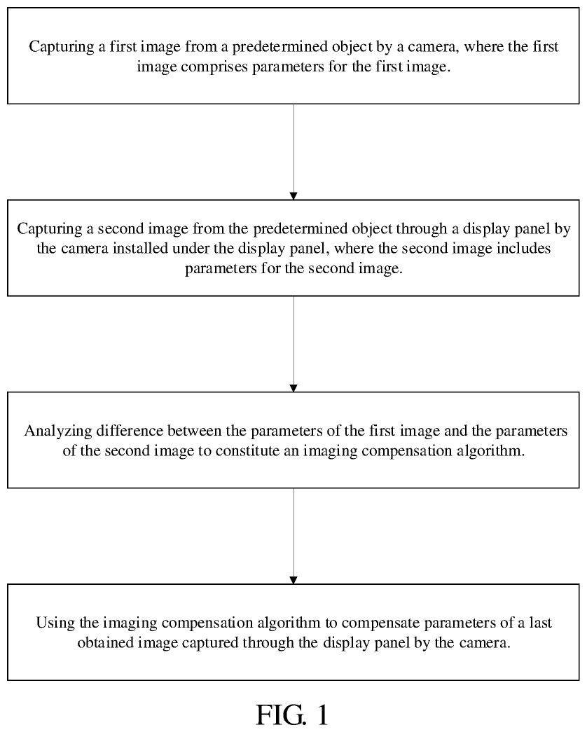

The embodiment provides an imaging compensation method. With reference to FIG. 1, a flowchart of imaging compensation method according to the embodiment of the invention is provided. The imaging compensation method includes the following steps:

A step of capturing a first image from a predetermined object by a camera directly, wherein the first image comprises parameters for the first image.

A step of capturing a second image from the predetermined object through a display panel by the camera installed under the display panel, wherein the second image includes parameters for the second image.

A step of analyzing difference between the parameters of the first image and the parameters of the second image to constitute an imaging compensation algorithm.

A step of using the imaging compensation algorithm to compensate parameters of a last obtained image captured through the display panel by the camera.

The predetermined object comprises a number of two or more objects. The parameters of the first image and the parameters of the first image include a grayscale value, a resolution, and a chromaticity.

The embodiment further provides an imaging compensation device comprising a memory and a processor. The memory stores a first image obtained from capturing a predetermined object by a camera. The first image comprises parameters for the first image. The camera is installed under a display panel and captures the predetermined object to obtain a second image. The second image is stored in the memory and includes parameters for the second image. The processor analyzes difference between the parameters of the first image and the parameters of the second image to generate an imaging compensation algorithm, and uses the imaging compensation algorithm to compensate parameters of a last obtained image captured through the display panel by the camera.

The predetermined object comprises a number of two or more objects. The parameters of the first image and the parameters of the first image include a grayscale value, a resolution, and a chromaticity.

The camera with imaging compensation is utilized to compensate each pixel of images captured by the camera installed under an array of display pixels in aspects of grayscale, color cast, and resolution, and thus to improve imaging quality of an under-screen camera.

### Embodiment 2

The embodiment provides a terminal device including a body equipped with an under-screen camera on the body. The under-screen camera comprises a lens, a sensor, an analog to digital converter, and a digital signal processing chip. The digital signal processing chip comprises an image signal processor and the imaging compensation device of the embodiments 1.

In an alternative embodiment, the terminal device includes a mobile phone.

The under-screen camera captures scenes through the lens, projects optical images onto the sensor. The optical image is converted into electrical signals, which is then converted by the analog to digital converter into digital signals. The digital signals are processed by the digital signal processing chip, and then sent to and processed by a processor of the mobile phone, and eventually converted into an image that is visible on the phone display.

A DSP chip mainly optimizes digital signals and parameters of images through a series of complex mathematical algorithms and sends the processed signals through an interface, such as universal serial bus (USB).

In the current under-screen camera technology, light beams have to pass through the display panel and may suffer from loss before entering into the camera lens for imaging. Layered structure with layers of polarizers and a layer of metal cathode film in the current display panel have low transmittance. The polyimide (PI) substrate of the current display panel is yellow and has extremely low transmittance for shorter wavelength segments of natural light. Additionally, a display area on top of the under-screen camera performs regular display functions, and inherently has an array structure of pixels which is light blockage. Therefore, the under-screen camera shooting through the display panel greatly affects imaging equality and causes various defects, such as image color cast, resolution deterioration, and even image edge blurring and distortion.

An embodiment of the invention provides an imaging compensation device comprising a memory and a processor. The memory stores a first image obtained from capturing a predetermined object by a camera. The first image comprises parameters for the first image. The camera is installed under a display panel and captures the predetermined object to obtain a second image. The second image is stored in the memory and includes parameters for the second image. The processor analyzes difference between the parameters of the first image and the parameters of the second image to constitute an imaging compensation algorithm, and uses the imaging compensation algorithm to compensate parameters of a last obtained image captured through the display panel by the camera.

In the process of each subsequent shooting, when the image signal processor in the digital signal processing chip performs optimization of digital signals and parameters of images, the imaging compensation device of the under-screen camera may cooperate with the image signal processor to improve camera imaging through imaging compensation on the aspects of color cast and resolution.

In grayscale compensation for the last obtained image, the image signal processor compensates grayscale values of the last obtained image by adjusting display brightness. In resolution compensation for the last obtained image, the image signal processor compensates resolution of the last obtained image by adjusting display clarity. In chromaticity compensation for the last obtained image, the image signal processor use an auto white balance (AWB) algorithm to compensate chromaticity of the last obtained image.

The beneficial effect of the present invention is: the present invention provides an imaging compensation device, an imaging compensation method, and an application. A DSP chip in the under-screen camera has a built-in imaging compensation device. The imaging compensation device includes a memory and a processor. The memory stores a first image obtained from directly capturing a predetermined object by a camera. The first image comprises first image parameters. The camera is installed under a display panel. The camera obtains a second image from capturing the predetermined object through the display panel. The second image is stored in the memory and includes second image parameters. The processor analyzes the difference between the first image parameters of the first image and the second image parameters of the second image to form an imaging compensation algorithm, and uses the imaging compensation algorithm to compensate image parameters of a last obtained image captured by the camera through the display panel.

Through the camera design with the imaging compensation function, every pixel of images captured by the camera under an array of display pixels is compensated in grayscale, color cast, and resolution to improve under-screen camera imaging.

The foregoing description is merely the preferred embodiments of the present invention. It should be appreciated that a person having ordinary skills in the art, without departing from the principles of the invention, may also make improvement and modification, which should also be regarded as belonging to the claims of the invention.

What is claimed is:

1. An imaging compensation device, comprising:
a memory; and
a processor;
wherein the memory stores a first image obtained from capturing a predetermined object by a camera, the first image comprises parameters for the first image, the camera is installed under a display panel and captures the predetermined object to obtain a second image, the second image is stored in the memory and includes parameters for the second image;
the processor analyzes difference between the parameters of the first image and the parameters of the second image to constitute an imaging compensation algorithm, and uses the imaging compensation algorithm to compensate parameters of a last obtained image captured through the display panel by the camera.

2. The imaging compensation device of claim 1, the predetermined object comprises a number of two or more objects.

3. The imaging compensation device of claim 1, wherein the parameters of the first image and the parameters of the first image include a grayscale value, a resolution, and a chromaticity.

4. An imaging compensation method comprising:
capturing a first image from a predetermined object by a camera, wherein the first image comprises parameters for the first image;
capturing a second image from the predetermined object through a display panel by the camera installed under the display panel, wherein the second image includes parameters for the second image;
analyzing difference between the parameters of the first image and the parameters of the second image to constitute an imaging compensation algorithm; and
using the imaging compensation algorithm to compensate parameters of a last obtained image captured through the display panel by the camera.

5. The imaging compensation method of claim 4, the predetermined object comprises a number of two or more objects.

6. The imaging compensation method of claim 4, wherein parameters of the first image and the second parameter include a grayscale value, a resolution, and a chromaticity.

7. A terminal device including a body equipped with an under-screen camera on the body, wherein the under-screen camera comprises a lens, a sensor, an analog to digital converter, and a digital signal processing chip, the digital signal processing chip comprises an image signal processor and the imaging compensation device of claim 1.

8. The terminal device of claim 7, the predetermined object comprises a number of two or more objects.

9. The terminal device of claim 7, wherein parameters of the first image and the second parameter include a grayscale value, a resolution, and a chromaticity.

10. The terminal device of claim 9, wherein in compensating the grayscale value of the last obtained image, the image signal processor compensates the grayscale value of the last obtained image by adjusting display brightness.

11. The terminal device of claim 9, wherein in compensating the resolution of the last obtained image, the image signal processor compensates the resolution of the last obtained image by adjusting display clarity.

12. The terminal device of claim 7, wherein the terminal device comprises a mobile phone.
